(19) United States
(12) Patent Application Publication
(10) Pub. No.: US 2023/0270144 A1
(43) Pub. Date: Aug. 31, 2023

(54) METHOD FOR THE PREPARATION OF POTATO CHIPS AND CHIPS OBTAINED BY SAID PROCES

(71) Applicant: Antonio CAPDEVILA ESPEJA, Zaragoza (ES)

(72) Inventor: Antonio CAPDEVILA ESPEJA, Zaragoza (ES)

(21) Appl. No.: 18/000,388

(22) PCT Filed: Sep. 3, 2020
(86) PCT No.: PCT/ES2020/070528

§ 371 Date: Nov. 30, 2022

(30) Foreign Application Priority Data
Jun. 10, 2020 (ES) 202030562

(51) Int. Cl. A23L 19/18; A23L 19/00; A23L 3/36; A23L 5/10

(52) U.S. Cl. CPC A23L 19/18; A23L 3/36; A23L 5/10; A23L 19/05

(57) ABSTRACT

Method for preparing potato chips, comprising the following steps in a central kitchen: - subjecting the potato to a thermal treatment of cooking by single-layer immersion, vacuum cooking or steam cooking,- subjecting the potato to a scan to record its shape and size,- determining the position of cuts on the potato model,- determining the position of a hole with a single inlet in each portion,- performing the mechanical emptying of the holes, recovering a cap for each hole,- injecting a filling into each hole and covering each hole with the caps,- performing the mechanical cutting of the potato into the predetermined portions,- performing a pre-frying of the portions,- cooling and deep-freezing the filled and pre-fried portions, and- packaging the already frozen portions; comprising a step of preparation at the place of consumption, comprising heating the portions.

### PURPOSE OF THE INVENTION

The present invention relates to a method for preparing potato chips and to the chips obtained by such a process. It belongs to the technical field of the food industry.

### BACKGROUND OF THE INVENTION

Currently, the preparation of potato chips, especially in food establishments, comprises frying potatoes in portions, either by slicing the portions in situ starting from whole potatoes after peeling them, normally, or more frequently, especially in fast-food establishments, by frying in situ portions of whole potatoes previously sliced into strips or slices (and peeled where appropriate), and frozen.

This method limits the possibility of increasing the flavour of the potato chips obtained by means of additives.

To solve this problem, the applicant is also the holder of invention patent P201731042, concerning a method for preparing chips and the chips obtained by said method, wherein the method comprises the following steps carried out in the central kitchen:
-shaping whole potatoes by cutting them into sliced portions,
-frying the portions of sliced potatoes,
-injecting one or more sauces into the sliced and fried potato portions,
-freezing the portions of the potatoes sliced, fried and injected with one or more sauces, and
-packaging for distribution;

Including a step for preparation at the place of consumption comprising heating the potato portions chopped, fried, injected with one or more sauces and frozen; and wherein the potato chips obtained, which comprise heated potato portions previously obtained by chopping by cutting whole potatoes, frying and injecting with one or more sauces, are preferably wedge-shaped, and the sauces employed could be any, for example:
sweet sauces,
salty sauces,
sweet and sour sauces,
cheese-based sauces (Cheddar, Cabrales, etc.),
spicy sauces.

With this invention it is possible to add different flavours to the potatoes, with the additional advantage that the final preparation of the potatoes in situ is much faster, since it only requires heating them, not frying them.

However, at times during the preparation stage at the place of consumption that comprises heating the potato portions chopped, fried, injected with one or more sauces and frozen, excessive heat during this stage could produce the exit of the filling due to excessively rapid increase of the temperature, which requires a careful control of the temperature in this stage.

This drawback is solved by using the method of this invention, which obtains as invention a potato that has better properties in the face of this problem.

### DESCRIPTION OF THE INVENTION

The method for preparing potato chips of the invention comprises the following steps carried out in a central kitchen:
subjecting the whole potato, sometimes with skin at sometimes without, to a thermal treatment of cooking by monolayer immersion, vacuum cooking or steam cooking, so that no potatoes placed on top damages one placed below.
subjecting the potato to a computer vision scan to record its shape and size,
determining on the obtained potato model the optimal position of cuts, to subsequently form a selected number of portions,
determining on each portion thus predetermined, the position of a hole with a single inlet orifice (this implies that the hole does not reach the bottom of the potato), to be filled later,
performing a mechanical emptying of the specified holes, recovering a cap for each hole,
injecting or mechanically inserting a filler into each hole obtained, and covering each one with the corresponding cap,
performing a mechanical cutting of the potato in the determined portions, such that these cuts will not affect the specified and filled holes,
passing these wedge-shaped portions through a mixture of spices and/or vegetable flours, which generates a coating and seals the wound by fixing the cap to the portion perfectly.
performing a pre-frying of the portions,
cooling and deep-freezing the filled and pre-fried portions, and
packing the deep-frozen portions, storing and transporting them to the final preparation site under suitable cold conditions;
comprising a step of preparation at the place of consumption, comprising heating the pre-fried and deep-frozen portions injected with one or more frozen sauces.

Before the start of the process, the potatoes are received for example in large format bags of 1000 kg, and are stored at a temperature between 5- 10 degrees for a maximum of 72 hours, before they are introduced in the production line, for example by forklift or crane, from which they are unloaded in the feed hopper of the cooking line. On the other hand, the packaging for distribution can be done in different formats: for large distribution, hospitality, individuals and any other sector that could demand it, while the heating corresponding to the preparation in the place of consumption can be done by any usual means in the kitchen: oven, microwave oven, immersion in oil, heated showcase or vending machine, etc.

The filler can be any flavoured substance preparation or mixture, whether in liquid, viscous, semi-viscous, solid, or semi-solid form, capable of being injected or introduced mechanically.

The method provides portions of potato with or without skin and heated, previously obtained by a heat treatment for cooking by single-layer immersion, vacuum cooking or steam cooking, scanning by artificial vision to record their shape and size, determination on the model of the optimal position of the cuts to form a number of selected segments and the position on each portion of a hole with a single entry orifice, injected or mechanically introducing a filling in each hole with and capping of the entry hole by means of a potato cap recovered when making the hole, cutting of the portions, wrapping in specified cover and pre-frying thereof, deep-freezing of the portions and packaging for conservation and transport to the place of heating for consumption, achieving subsequent rehydration in a pan, fryer, oven, microwave oven, hot showcase or vending machine, almost immediately. Providing an explosion of flavour in the consumer’s mouth.

### DESCRIPTION OF A PRACTICAL EMBODIMENT OF THE INVENTION

The method for preparing potato chips of the invention comprises the following steps carried out in a central kitchen:
subjecting the potato to a thermal treatment of cooking by single-layer immersion, vacuum cooking or steam cooking,
subjecting the potato to a scan (by artificial vision ideally, i.e. by means of cameras and contour processing) to record its shape and size,
determining on the obtained potato model the optimal position of some cuts to subsequently form a selected number of portions,
determining on each predetermined portion the position of a hole with a single inlet orifice to be filled subsequently,
performing a mechanical emptying of the specified holes, recovering a cap for each hole,
injecting or mechanically inserting a filling into each hole obtained, and covering each one with the corresponding cap,
performing a mechanical cutting of the potato into the determined portions, such that these cuts will not affect the specified and filled holes,
pre-frying the portions,
cooling and deep-freezing the filled and pre-fried portions, and
packing the frozen portions and storing and transporting them to the final preparation site under suitable cold conditions;
comprising a step of preparation at the place of consumption, comprising heating the pre-fried and deep-frozen portions injected with one or more frozen sauces.

Most preferably, a granular or powdery coating can be applied to the portions before the pre-frying step, since this increases their resistance against the increase in pressure that can occur in the filling due to the during pre-frying, preventing the filling from coming out. Said coating comprises for example a mixture of spices and/or vegetable flours that further improves the taste.

Ideally, the immersion cooking heat treatment is performed with the unpeeled potato, reducing processing costs and improving the taste and appearance, as the skin is incorporated into the final product. Said thermal treatment of cooking by monolayer immersion, vacuum cooking or steam cooking is preferably carried out at a temperature between 80-90 degrees for 7 minutes, which manages to keep the skin of the product intact.

The mechanical emptying of the holes is preferably carried out by means of a tubular blade, which when descending carves the potato and retains the potato body or core corresponding to the hole when the blade exits; while the recovery of the cap for the hole is carried out by recovering one of the ends of the removed core.

On the other hand, the cuts that determine the portions are made by means of a single cut with a guillotine with radial branches, circular blades or metallic wire, obtaining portions in the form of a wedge, since it is carried out in a single operation. Ideally, the tubular blade and the guillotine with radial branches, circular blades or metallic wire move vertically on each potato to be processed. Likewise, with this arrangement the injection of the filler can be carried out by means of an injector needle provided with movement in the same direction as that of the tubular blade (vertical).

As for the pre-frying step, it is performed by continuous fryer, allowing implementation of in-line continuous production, and the deep-freezing of the potato portions is performed at a temperature of -35 degrees at least, also preferably in a spiral freezing tunnel, or continuously.

The filling, on the other hand, can be based on:
sweet sauces,
salty sauces,
sweet and sour sauces,
cheese-based sauces,
spicy sauces,
cheese creams,
creams of all kinds of food.,
crushed fruit,
chocolates.

The product obtained is potato chips comprising heated potato portions, previously obtained by a heat treatment of monolayer immersion cooking, vacuum cooking or steam cooking, scanning to record their shape and size, determination on the model of the optimal position of the cuts to form a selected number of portions and the position on each portion of a hollow with a single inlet hole, injected or mechanically introduced into each hole with a filling and capping of the inlet hole by means of a potato cap recovered when performing the hollow, cutting of the portions ideally in the shape of a wedge, and may or may not comprise a granular or powdery covering, which may be a mixture of spices and/or vegetable flours and pre-frying thereof, deep-freezing of the portions and packaging for preservation and transport to the place of heating for consumption.

The filling of the portions can be based on:
sweet sauces,
salty sauces,
sweet and sour sauces,
cheese-based sauces (Cheddar, Cabrales, etc.),
spicy sauces,
cheese creams,
creams of all kinds of food.,
crushed fruit,
chocolates.

Having sufficiently described the nature of the invention, as well as the manner in which to embody it in practice, it should be noted that the preceding provisions are susceptible to changes in detail that do not alter the main principle.

1. A method for the preparation of potato chips, comprising the following steps:
subjecting a potato to a thermal treatment of cooking by single-layer immersion, vacuum cooking or steam cooking;
subjecting the potato to a scan to record its shape and size and creating a potato model;
determining on the obtained potato model an optimal position of some cuts to subsequently form a selected number of portions;
determining on a predetermined portion from the selected number of portions the position of a determined hole with a single inlet orifice to be filled subsequently;
performing a mechanical emptying of the specified holes, recovering a cap for each hole;
injecting or mechanically inserting a filler into each gap obtained from the mechanical emptying of the specified holes, and covering each one with the corresponding cap;
performing a mechanical cutting of the potato into the predetermined portions, without affecting the determined hole, and filling;
performing a pre-frying of the predetermined portions;
cooling and deep-freezing the filled and pre-fried predetermined portions; and
packaging the previously frozen predetermined portions and storing and transporting them to a final preparation site under suitable cold conditions;
heating the predetermined portions injected with one or more frozen, pre-fried and deep-frozen sauces.

2. The method for the preparation of potato chips according to claim 1, wherein a granular or powdery coating is applied to the predetermined portions prior to the pre-frying step.

3. The method for the preparation of potato chips according to claim 2, wherein the coating comprises a mixture of spices and/or vegetable flours.

4. The method for the preparation of potato chips according to claim 1, wherein the immersion cooking heat treatment is performed with peeled or unpeeled potatoes.

5. The method for the preparation of potato chips according to claim 1, wherein the heat treatment of cooking by single-layer immersion, vacuum cooking or steam cooking is carried out at a temperature of between 80-90 degrees centigrade for 7 minutes.

6. The method for the preparation of potato chips according to claim 1, wherein the mechanical emptying of the specified holes is carried out by means of a tubular blade to retain a potato body or core corresponding to the hole when leaving; while the recovery of the cap for the hole is carried out by recovering one of the ends of an extracted core.

7. The method for the preparation of potato chips according to claim 1, wherein the cuts that determine the predetermined portions are made by a single cut with a guillotine with radial branches, circular blades or metallic wires, obtaining portions in the form of a wedge.

8. The method for the preparation of potato chips according to claim 7, wherein the tubular blade and the guillotine with radial branches, circular blades or metallic wires have a vertical movement on each potato to be processed.

9. The method for the preparation of potato chips according to claim 8, wherein the injection or mechanical insertion of the filling is carried out by means of an injector needle provided with movement in the same direction as that of the tubular blade.

10. The method for the preparation of potato chips according to claim 1, wherein the pre-frying step is carried out by a continuous fryer.

11. The method for the preparation of potato chips according to claim 1, wherein the deep-freezing of the predetermined portions is carried out at a temperature of -35 degrees centigrade, at least.

12. The method for the preparation of potato chips according to claim 1, wherein the deep-freezing of the predetermined portions is carried out in a spiral freezing tunnel, or continuously.

13. The method for the preparation of potato chips according to claim 1, wherein the filling is selected from: sweet sauces, salty sauces, sweet and sour sauces, cheese-based sauces, spicy sauces, cheese creams, creams of all kinds of food crushed fruit, chocolates.

14. A potato chip, comprising heated predetermined portions, previously obtained by a heat treatment of single-layer immersion cooking, vacuum cooking or steam cooking, scanning to model their shape, determination on the model of an optimal position of the cuts to form a selected number of segments and of the position on each portion of a hole with a single entry orifice, injecting each hole with a filling and capping the entry hole by means of a potato cap recovered when making the hole, cutting the predetermined portions and pre-frying them, ultra-freezing the portions and packaging for conservation and transport to the place of heating for consumption.

15. The potato chip according to claim 14, wherein the predetermined portions are shaped like a wedge.

16. The potato chip according to claim 14, wherein the predetermined portions comprise a granular or powdery coating.

17. The potato chip according to claim 16 wherein the coating is a mixture of spices and/or vegetable flours.

18. The potato chip according to claim 14, wherein the sauces are selected from: sweet sauces, salty sauces, sweet and sour sauces, cheese-based sauces, spicy sauces, cheese creams, creams of all kinds of foodcrushed fruit, chocolates.
